(19) United States
(12) Patent Application Publication
(10) Pub. No.: US 2023/0107247 A1
(43) Pub. Date: Apr. 6, 2023

(54) NEURAL NETWORKS WITH TRANSFORMED ACTIVATION FUNCTION LAYERS

(71) Applicant: DeepMind Technologies Limited, London (GB)

(72) Inventors: James Martens, London (GB); Guodong Zhang, Toronto (CA); Grzegorz Michal Swirszcz, London (GB); Andrew James Ballard, London (GB); Guillaume Desjardins, London (GB)

(21) Appl. No.: 17/959,232

(22) Filed: Oct. 3, 2022

Related U.S. Application Data
(60) Provisional application No. 63/251,566, filed on Oct. 1, 2021.

(51) Int. Cl. G06N 3/04; G06N 3/08

(52) U.S. Cl. CPC G06N 3/0481; G06N 3/08

(57) ABSTRACT

Methods, systems, and apparatus, including computer programs encoded on computer storage media, for processing inputs using a neural network system that includes one or more transformed activation function layers.

### CROSS-REFERENCE TO RELATED APPLICATION

This application claims priority to U.S. Provisional Application No. 63/251,566, filed on Oct. 1, 2021. The disclosure of the prior application is considered part of and is incorporated by reference in the disclosure of this application.

### BACKGROUND

This specification relates to processing inputs through the layers of neural networks to generate outputs.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that processes an input using a neural network that includes transformed activation function layers to generate a network output.

In one aspect there is described a method performed by one or more computers, comprising receiving a network input, e.g., during training of the neural network, and processing the network input using a neural network that comprises a plurality of neural network layers arranged as a directed graph to generate a network output for the network input. The plurality of neural network layers comprises a plurality of transformed activation function layers. Processing the network input comprises, for each transformed activation function layer, receiving a layer input for the transformed activation function layer, and generating, from the layer input, an activation input to an element-wise activation function for the transformed activation layer. Processing the network input further comprises transforming the activation input using one or more input transformation constants to generate a transformed activation input, and applying the element-wise activation function to the transformed activation input to generate an initial activation output. Processing the network input also comprises transforming the initial activation output using one or more output transformation constants to generate a transformed activation output. The one or more input transformation constants and the one or more output transformation constants are based on properties of the neural network when the neural network is initialized prior to training the neural network. The transformed activation output is provided as a layer output for the transformed activation function layer.

In broad terms the input transformation constant(s) and the output transformation constant(s) provide additional degrees of freedom for the activation function, that allow the neural network to be configured so as to be easier to train, e.g., without the need for batch normalization layers or skip connections. The particular constants can be chosen according to the type of activation function. For example for some activation functions the constants can define a scale (multiplication) and/or shift (addition) to the activation input or output; for others a more complex operation can be defined. For example for a “leaky RELU” activation function (a rectified linear activation function with a non-zero slope for negative input values) the constants may define a generally bell-shaped weighting centered around zero. In general one or more of the constants may be zero or unity.

Particular values for the constants can be determined in a variety of ways, as described in detail later. As one example, values for the constants for each of the layers may be selected such one or more constraints that are based on values of local C maps and or local Q maps for the plurality of layers in the neural network are satisfied.

In this context a local C map may be a function that characterizes how well a cosine similarity function (between two neural network layer inputs) is preserved between the input and the output of a neural network layer. The local C map can represent a function of a value c, where c can represent an approximation of the cosine similarity of a previous layer (and where c-values can be determined iteratively).

A local Q map may be a function that characterizes a change, e.g., a contraction or expansion, in a squared magnitude of the element-wise activation function between the input and the output of a neural network layer. The local Q map can represent a function of a value q, where q can represent a kernel function of a layer input value. A value for the kernel function depends on the activation function and can be computed in expectation, e.g., by sampling values from a distribution; it may be determined iteratively, layer-by-layer.

As one example, a global C map for the neural network may be determined from a (function) composition local C maps for the plurality of neural network layers. Then the input and output transformation constants may be selected based on a constraint on the global C map, e.g., on that represents preservation of the cosine similarity function by the neural network. Various examples of this are given later for different types of activation function; in general numerical techniques can be used to determine values for the constant(s). This constraint can help ensure that the neural network's output preserves useful information during training, without any particular constraint on the network architecture or type of activation function. In some implementations a constraint may also be applied to a first derivative of the global C map.

As another example, the input and output transformation constants may be selected based on a constraint on the local Q map, e.g., that this has a particular output value for a particular input value, e.g., that Q(1)=1 or that Q(q)=q. Such constraints on changes between the layer input and layer output can also facilitate trainability.

The method may, but need not be, performs during or at the beginning of a training process of a neural network. Particular embodiments of the subject matter described in this specification can be implemented so as to realize one or more of the following advantages.

Many deep neural networks are difficult to train quickly and fail to generalize well to unseen data after training. For example, many tasks require that the neural network have very specific architectural elements, e.g., batch normalization, ReLUs, skip connections, and so on, in order to be trained to perform well on the task. However, the requirement for including these specific architectural elements can make it difficult to design new neural network architectures or, more generally, to train neural networks that do not have these elements but might otherwise exhibit improved performance on these tasks.

This specification describes techniques for transforming the activation function layers of neural networks to eliminate the requirement for these elements and to allow neural networks to be trained effectively and quickly even when these elements are not included. Moreover, applying the described techniques results in neural networks that generalize better to unseen data after training, resulting in improved inference performance.

As a particular example, a neural network that otherwise could not have been trained in a reasonable amount of time or with a reasonable amount of compute because it lacks one or more specific elements, e.g., skip connections or batch normalization, can instead be trained to exceed the performance of a conventional neural network that does have the specific elements (if the neural network being trained includes the described transformed activation layers).

The techniques described in this specification can reduce usage of computational resources (e.g., memory and computing power) by a neural network by obviating the need to include architectural elements such as skip connections and normalization layers in the neural network. For instance, implementing a skip connection that “skips” a block in a neural network can require storing the input to the block while generating the output of the block, e.g., to enable the block input to be combined with (e.g., added to) the block output. Removing skip connections from a neural network thus reduces the memory footprint of the neural network by reducing temporary storage of intermediate outputs.

As a particular example, a neural network that could previously not be deployed on a target device because storing a block input while also using device memory to generate the output of the block exceeds the capacity of the device memory can, by virtue of transforming the activation functions of the layers of the neural network as described in this specification, be effectively trained without skip connections and can therefore be deployed on the target device after training.

Implementing a normalization layer can require performing computationally intensive operations by aggregating data to generate normalization constants, and removing normalization layers thus eliminates part of the computational footprint of the neural network.

By reducing usage of computational resources, the techniques described in this specification can enable neural networks to be trained or deployed in resource constrained environments. For instance, a neural network implemented using the transformed activation functions described in this specification can be trained or deployed on devices with fewer computational resources (e.g., memory and computing power) than would otherwise be necessary.

Even when normalization layers and skip connections can be included in a particular neural network without exceeding the compute budget for the network, a system designer may not where these components should be inserted in the neural network or if the insertion of the components will solve trainability issues with the neural network. The described techniques, on the other hand, are fully automated and solve trainability issues without any design or guesswork from the system designer. Moreover, in some contexts, using the described techniques in place of normalization layers and skip connections can improve the performance of the neural network.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2 is a flow diagram of an example process for processing an input using a transformed activation function layer.

FIG. 3 is a flow diagram of an example process for training a neural network that has transformed activation function layers.

FIG. 4 is a chart that shows the performance of the described techniques relative to a conventional technique.

Like reference numbers and designations in the various drawings indicate like elements.

### DETAILED DESCRIPTION

This specification describes systems implemented as computer programs on one or more computers in one or more locations that process inputs using a neural network that includes transformed activation function layers.

The neural network can be trained to perform any kind of machine learning task, i.e., can be configured to receive any kind of digital data input and to generate any kind of score, classification, or regression output based on the input.

In some cases, the neural network is a neural network that is configured to perform an image processing task, i.e., receive an input image and to process the input image, i.e., to process intensity values of the pixels of the image, to generate a network output for the input image. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories.

As another example, if the inputs to the neural network are Internet resources (e.g., web pages), documents, or portions of documents or features extracted from Internet resources, documents, or portions of documents, the task can be to classify the resource or document, i.e., the output generated by the neural network for a given Internet resource, document, or portion of a document may be a score for each of a set of topics, with each score representing an estimated likelihood that the Internet resource, document, or document portion is about the topic.

As another example, if the inputs to the neural network are features of an impression context for a particular advertisement, the output generated by the neural network may be a score that represents an estimated likelihood that the particular advertisement will be clicked on.

As another example, if the inputs to the neural network are features of a personalized recommendation for a user, e.g., features characterizing the context for the recommendation, e.g., features characterizing previous actions taken by the user, the output generated by the neural network may be a score for each of a set of content items, with each score representing an estimated likelihood that the user will respond favorably to being recommended the content item.

As another example, if the input to the neural network is a sequence of text in one language, the output generated by the neural network may be a score for each of a set of pieces of text in another language, with each score representing an estimated likelihood that the piece of text in the other language is a proper translation of the input text into the other language.

As another example, the task may be an audio data processing task. An audio data input to the neural network may comprise a representation of a digitized audio waveform, e.g., a speech waveform. Such a representation may comprise samples representing digitized amplitude values of the waveform or, e.g., a time-frequency domain representation of the waveform. As one example of an audio processing task, if the input to the neural network is a sequence representing a spoken utterance, the output generated by the neural network may be a score for each of a set of pieces of text, each score representing an estimated likelihood that the piece of text is the correct transcript for the utterance. As another example, the task may be a keyword spotting task where, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram or other data defining audio of the text being spoken in the natural language.

As another example, the task can be a health prediction task, where the input is electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be an agent control task, where the input is an observation characterizing the state of an environment and the output defines an action to be performed by the agent in response to the observation. The agent can be, e.g., a real-world or simulated robot, a control system for an industrial facility, or a control system that controls a different kind of agent. As one more specific example the inputs to the neural network may comprise observations characterizing states of a real-world environment, e.g. from an image sensor or other sensors of or associated with the agent, to generate action control data for controlling the agent, e.g., a mechanical agent such as a robot or vehicle, operating in the real-world to perform a task such as manipulating or moving an object or navigating in the environment.

In particular, the neural network described in this specification can have any appropriate architecture, but with one or more of the layers in the architecture replaced with a transformed activation function layer, i.e., as described in the description below.

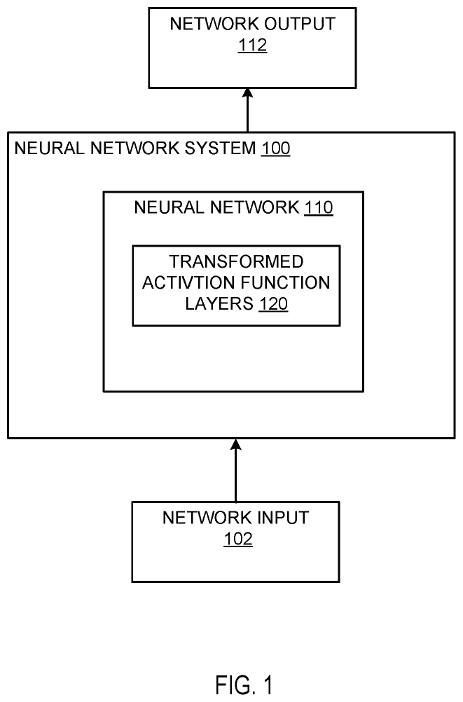

FIG. 1 shows an example neural network system 100. The neural network system 100 is an example of a system implemented as computer programs on one or more computers in one or more locations, in which the systems, components, and techniques described below can be implemented.

The neural network system 100 processes network inputs 102 using a neural network 110 to generate network outputs 112.

More specifically, the neural network 110 includes a plurality of neural network layers arranged as a directed graph and the neural network is configured to generate network outputs 112 from network inputs 102 by processing the network inputs 102 through each of the layers in the neural network in an order that is defined by the directed graph, i.e., so that the output of each layer is provided as input to any layers that are connected to the layer by an outgoing edge in the directed graph.

Generally, the plurality of neural network layers include a plurality of transformed activation function layers 120.

Unlike conventional layers with a non-linear activation function, a transformed activation function layer 120 transforms the input, the output, or both of the non-linear activation function using a set of scalar values (“constants”) for the layer that are fixed and do not change during training or after training, i.e., during inference.

A non-linear activation function is a function that applies a non-linear function to each element of a given activation input to generate a corresponding element of an activation output. Example of activation functions include rectified linear units (ReLU), leaky ReLU, Swish, sigmoid, tanh, and so on.

The neural network 110 can also include additional layers in addition to the transformed activation function layers, e.g., output layers, affine layers with no activation function (e.g., fully-connected layers or convolutional layers with no activation function), normalized summation layers, and so on.

More specifically, the neural network 110 can have any architecture that is made up of some combination of transformed activation function layers 120, affine layers with no activation function, normalized summation layers and output layers.

As a particular example, the neural network 110 can be generated by modifying an existing architecture. For example, the existing architecture can be modified to remove normalization layers, e.g., batch normalization or layer normalization layers, and to either remove the skip connections in the neural network or to replace the skip connections with normalized summation layers.

A normalized summation layer is a layer that receives, for each of a plurality of neural network layers that are connected to the normalized summation layer by an incoming edge in the directed graph, a respective layer output generated by the neural network layer during the processing of the network input 102. The normalized summation layer applies a respective normalized weight to each of the respective layer outputs to generate a respective weighted layer output and generates a layer output for the normalized summation layer by summing the respective weighted layer output. The weights are referred to as normalized weights because the squares of the weights are constrained to sum to one, i.e., the sum of the squares of the normalized weights sum to one.

For example, the neural network 110 can be generated from a ResNet architecture by removing the normalization layers and the skip connections or by removing the normalization layers and replacing each skip connection with a normalized summation layer that receives the same inputs as the skip connection.

More generally, as described above, the neural network system 100 can be configured to perform any kind of machine learning task, i.e., to receive any kind of digital data input and to generate any kind of score output, classification output, or regression output based on the input. As a particular example, any appropriate architecture for a neural network that performs a given machine learning task can be modified as described above to generate the neural network 110.

In particular, each of the layers of the neural network 110 is configured to receive an input and generate an output from the input and the neural network layers collectively process neural network inputs 102 received by the neural network to generate a respective neural network output 112 for each received neural network input 102.

Some or all of the neural network layers in the directed graph generate outputs from inputs in accordance with current values of a set of (trainable) parameters for the neural network layer, e.g., weights and optionally biases of the neural network layer. For example, some layers may be fully-connected layers that multiply the received input by a matrix of current parameter values as part of generating an output from the received input. As another example, some layers may be convolutional layers that perform a convolution between a filter bank of weights of the convolutional layer and the layer input to the layer. Such a filter bank may be defined by a filter bank tensor.

Prior to using the neural network 110 to process new inputs, the neural network system 100 trains the neural network to determine trained values of the parameters of the neural network, including the parameters of the transformed activation function layers 120.

In particular, the system 100 trains the neural network 110 on training data that includes multiple batches of training examples. A batch of training examples is a set of multiple training examples that each include a training network input and a target output for the training input that represents an output that should be generated by the neural network 110 by performing the machine learning task that the neural network 110 is configured for on the training network input.

For example, at each iteration during training, the neural network system 100 can process a batch of training examples and generate a respective neural network output for each training input in the batch. The neural network outputs can then be used to adjust the values of the parameters of the neural network layers, e.g., by computing, through conventional gradient descent and backpropagation neural network training techniques, gradients with respect to the parameters of a loss function for the neural network task, e.g., a cross-entropy loss, a negative log-likelihood loss, a mean squared error loss, and so on, that is based on the neural network outputs and the target outputs in the training example.

Thus, the parameters of the transformed activation function layers 120 and of any other layers with learnable weights are learned through gradient descent and backpropagation during the training of the neural network.

Prior to training the neural network 110 (also referred to as “at initialization”), the system 100 initializes the values of the parameters of the layers of the neural network 110, including the parameters of the transformed activation function layers 120, and determines the values of the constants for the transformed activation function layers 120.

During the training, the system 100 updates the parameter values of the layers 110, but keeps the values of the constants fixed.

In particular, the system 100 can determine the values of the constants based on properties of the network 110 at initialization.

More specifically, these properties include the type of activation functions employed by the transformed activation function layers 120.

In some implementations, these properties also include values of local C maps and local Q maps for the plurality of layers in the neural network.

In particular, given some initialization scheme for the weights of the layers of the neural network 110, e.g., a random initialization scheme, a deterministic kernel \tilde{k}_{f}^{l}(x₁, x₂) of the neural network 110 can be computed layer by layer such that:

$${\sum }^{l + 1} = {𝔼}_{z \sim ℵ ( 0 , {\sum }^{l} )} [ φ ( z ) {φ ( z )}^{T} ] , \\ where {\sum }^{l} = [ \begin{matrix}{\tilde{k}}_{f}^{l} ( {x}_{1} , {x}_{1} ) & {\tilde{k}}_{f}^{l} ( {x}_{1} , {x}_{2} ) \\ {\tilde{k}}_{f}^{l} ( {x}_{1} , {x}_{2} ) & {\tilde{k}}_{f}^{l} ( {x}_{2} , {x}_{2} )\end{matrix} ] ,$$

where \tilde{k}_{f}⁰(x₁, x₂)=x₁^{T}x₂/d₀, l denotes the l-th layer of the neural network, x₁ and x₂ are two network inputs, φ is the activation function for layer l+1, and d₀ is the dimensionality of the network inputs. Whilst at initialization weights of the neural network may be random, the above approach obtains an approximation of a deterministic kernel.

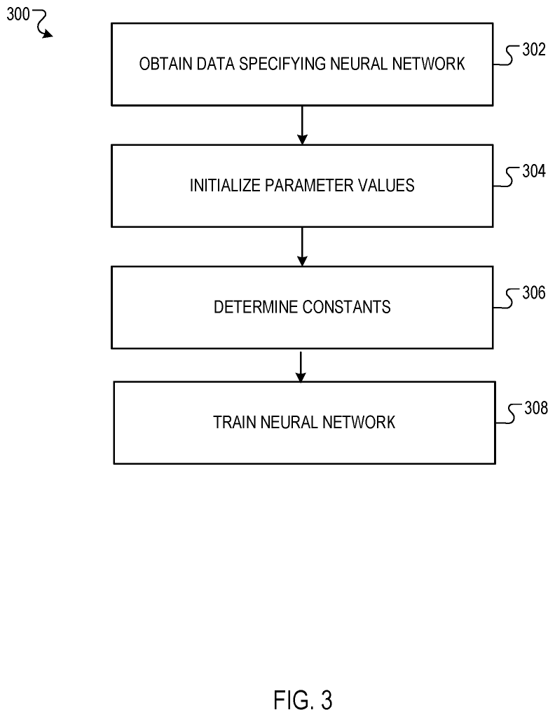

This is described in more detail below, for both fully-connected and convolutional layers, with reference to FIG. 3.

Given the above formulation, any diagonal entry qᵢ^{l+1} of Σ^{l+1} depends only on the corresponding diagonal entry qᵢ^{l}. Hence, these diagonal entries can be computed using a local Q map for a given neural network layer, where local Q map is a function that satisfies:

qᵢ^{l+1}=Q(qᵢ^{l})= [symbol] _{(0,q}_{ᵢ}_{^{l}}₎[φ(z)²]= [symbol] _{z˜N(0,q}_{ᵢ}_{^{l}}₎[φ(\sqrt{qᵢ^{l}z})²]

with qᵢ⁰=∥xᵢ∥²/d₀.

Thus, qᵢ^{l} is an approximation of the kernel \tilde{k}_{f}^{l}(xᵢ, xᵢ).

Given the above formulation, the normalized off-diagonal entries c^{l+1} of Σ^{l+1} can be computed using a local C map for a given neural network layer, where the local C map is a function that satisfies:

$${c}^{l + 1} = 𝒞 ( {c}^{l} , {q}_{1}^{l} , {q}_{2}^{l} ) = \frac{{𝔼}_{{z}_{1} , {z}_{2} \sim 𝒩 ( 0 , {\sum }^{l} )} [ φ ( {z}_{1} ) φ ( {z}_{2} ) ]}{\sqrt{𝒬 ( {q}_{1}^{l} ) 𝒬 ( {q}_{2}^{l} )}}$$

with

$${\sum }^{l} = [ \begin{matrix}{q}_{1}^{l} & \sqrt{{q}_{1}^{l} {q}_{2}^{l}} {c}^{l} \\ \sqrt{{q}_{1}^{l} {q}_{2}^{l}} {c}^{l} & {q}_{2}^{l}\end{matrix} ]$$

Thus, c^{l} is an approximation of the cosine similarity between the output of layer l for x₁ and the output of the layer l for x₂.

Because [symbol] is a three dimensional function, it is difficult to analyze, as the associated q values can vary significantly for distinct inputs. However, by scaling the inputs to have norm \sqrt{d₀} and, as will be described below, rescaling φ so that Q(1)=1, it follows that qᵢ^{l}=1 for all l. This allows [symbol] to be treated as a one dimensional function from [−1; 1] to [−1; 1] satisfying [symbol] (1)=1.

In some implementations the system 100 can apply normalization to each network input 102 before the network input is processed by the neural network 110 to generate a normalized input. As one example, the system 100 can normalize each network input 102 so that the norm of the network input 102 is equal to \sqrt{d₀}. As another example, the condition above is also satisfied by applying per-location normalization to elements of the network input 102. That is, the system 100 can provide the normalized input as a layer input for the initial neural network layer of the neural network 110, i.e., to the layer represented by the initial node in the directed graph.

The system can also compute a global C map [symbol] _{f} and a global Q map Q_{f} for the neural network from the local C maps and the local Q maps. That is, the system can determine a global C map for the neural network 110 as a composition of the local C maps for the layers, e.g., [symbol] _{f}(⋅)=C(⋅)∘C(⋅) . . . ∘C(⋅), and determine the global Q map for the neural network 110 as a composition of the global Q maps.

When computed as above, global Q and C maps characterize signal propagation through the neural network 110 at initialization time. The q value approximates the squared magnitude of the activation, so that Q_{f} describes the contraction or expansion of this magnitude through the action of the neural network 110.

On the other hand, the c value approximates the cosine similarity of the function values for different inputs, so that [symbol] _{f} describes how well the neural network 110 preserves this cosine similarity from its input to its output.

In some implementations the constant values for the layers 120 are selected so that certain constraints on the local C maps and local Q maps (and therefore the global C and Q maps) are satisfied, the system 100 can ensure that local and global C and Q maps are well-behaved, and allow the neural network 110 to be more effectively trained even when components like normalization layers and, in some cases, residual connections (also referred to as “skip connections”) are removed.

As described above, when skip connections are not removed, the system replaces the skip connections with normalized summation layers. Normalized summation layers are used because, unlike, un-normalized skip connections, they maintain the property that all q values are 1 in the network.

These constraints and selecting the constant values are described in more detail below with reference to FIG. 3.

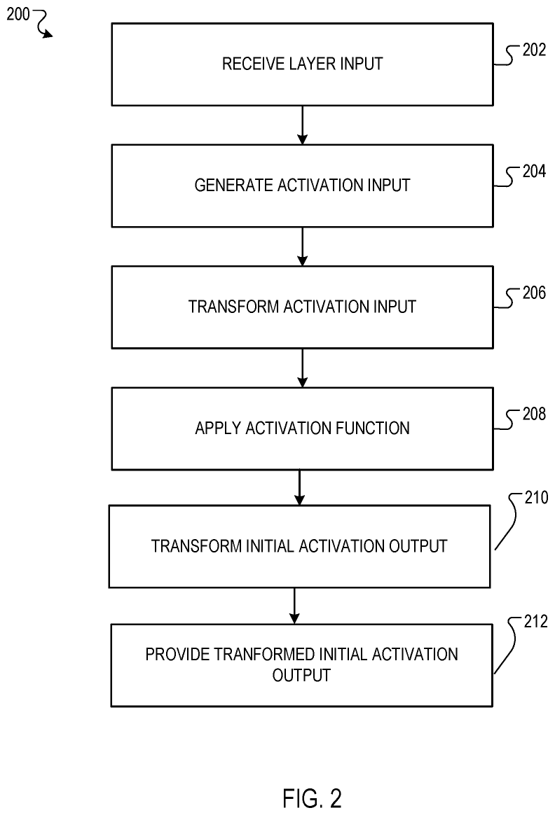

FIG. 2 is a flow diagram of an example process 200 for processing an input using a transformed activation function layer. For convenience, the process 200 will be described as being performed by a system of one or more computers located in one or more locations. For example, a transformed activation function layer included in a neural network system, e.g., one of the transformed activation function layers 120 included in the neural network system 100 of FIG. 1, appropriately programmed, can perform the process 200.

The process 200 can be performed during inference, i.e., after the neural network has been trained, or during training, i.e., as part of the forward pass through the neural network to compute a network output for a training input and to later update the values of the parameters of the transformed activation function layer and the other layers in the neural network by computing a backward pass through the neural network. That is, when the process 200 is performed during training,

Generally, the transformed activation function layer is configured to receive a layer input that has a plurality of elements. For example, the layer input can be a vector, a matrix, or a higher-order tensor, e.g., a feature map that has multiple channels.

If the transformed activation function layer is the initial layer in the directed graph, the layer input is the network input. If not, the layer input is an output generated by one or more other layers in the plurality of neural network layers, i.e., the output of the one or more other layers that are connected to the transformed activation function layer by an incoming edge in the directed graph.

The transformed activation function layer receives the layer input for the transformed activation function layer (step 202).

The transformed activation function layer generates, from the layer input, an activation input to an element-wise activation function for the transformed activation layer (step 204).

In some implementations, the layer applies an affine operation, e.g., a convolution or a matrix multiplication optionally filed by a summation with a bias, to the layer input to generate the activation input. Depending on the type of affine operation, the activation input can have the same number of elements as the layer input or a different number of elements.

In some other implementations, the layer uses the layer input as the activation input, i.e., when the layer only applies an activation function and not an affine transformation.

The layer transforms the activation input using one or more input transformation constants to generate a transformed activation input (step 206), applies the element-wise activation function to the transformed activation input to generate an initial activation output (step 208), and transforms the initial activation output using one or more output transformation constants to generate a transformed activation output (step 210).

That is, instead directly applying the activation function to the activation input and then providing the output of the activation function as the layer output, the layer modifies the input to the function, the output of the function, or both.

As described above, the input transformation constants and the output transformation constants are fixed and do not change during training of the neural network or during inference.

In particular, the one or more input transformation constants and the one or more output transformation constants are based on properties of the neural network when the neural network is initialized prior to training the neural network.

As one example, given an activation function φ, the transformed activation output \hat{φ} (x) for an activation input x can be equal to:

\hat{φ} (x)=γ(φ(αx+β)+δ),

where α and β are the input transformation constants, and δ and γ are the output transformation constants.

Thus, in this example, as part of transforming the activation input using one or more input transformation constants, the system generates an initial transformed activation input ax by multiplying the activation input by an input scale constant α. The system then generates the transformed activation input by adding an input shift constant β to the initial transformed activation input αx. As part of transforming the initial activation output using one or more output transformation constants to generate a transformed activation output, the system generates a shifted initial activation output by adding an output shift constant δ to the activation output. The system then generates the transformed activation output by multiplying the shifted initial activation output by an output scale constant γ.

In this example, prior to training the neural network, the system determines values of the input transformation constants α and β and the output transformation constants δ and γ and keeps the values constant through training and after training.

As another example, when the activation function is a leaky rectified linear unit (ReLU) activation function φ_{α}, the transformed activation output [symbol] (x) for an activation input x can be equal to:

$$( x ) = \sqrt{\frac{2}{1 + {α}^{2}}} ( {φ}_{α} ( x ) ) ,$$

where φ_{α}(x) is the leaky ReLU function that, for a given element of the activation input, (i) is an identity operation when the given element is greater than or equal to zero and (ii) multiplies the given element by a slope value α when the given element is less than zero. That is, φ_{α}(x) satisfies:

φ_{α}(x)=max{x,0}+α min{x,0}.

Thus, in this example, the input transformation is the identity, so that the transformed activation input is equal to the activation input. That is, the above equation can be considered to be equivalent to setting an input scale constant equal to one so that the input transformation is the identity transformation.

Additionally, in this example, the system generates the transformed activation output by multiplying the shifted initial activation output by an output scale constant that is defined by the slope value α. In particular, as can be seen from the above equation, the output scale constant is equal to a square root of a ratio between (i) 2 and (ii) a sum of one and a square of the slope value.

In this example, prior to training the neural network, the system determines the value of the slope value α and, therefore, of the output scale constant and keeps the value constant through training and after training.

Determining the values of the constants in the above examples is described below with reference to FIG. 3.

The layer provides the transformed activation output as a layer output for the transformed activation function layer (step 212).

When the process 200 is being performed during training and once the final layer in the directed graph has generated the network output, the system can obtain a target network output for the network input. The target network output is a “ground truth” output that should be generated by the neural network by processing the network input.

The system can determine a gradient with respect to a set of parameters of the neural network of a loss function for the training of the neural network dependent on the network output relative to the target network output, e.g., that measures a quality of the network output relative to the target network output. In particular the “quality of the network output” may characterize or measure a performance of the neural network on a task for which the neural network is being trained. The loss function can be any appropriate loss function for the task that the neural network is configured to perform. Examples of such loss functions include cross-entropy losses, maximum log-likelihood based losses, mean squared error based losses, and so on.

The system can then determine an update to the parameters of the neural network based at least on the gradient, e.g., by backpropagating the gradient. As described above, because the transformed activation function layers replace layers with conventional activation functions in the network, the neural network does not need to include certain specialized components, e.g., normalization layers and, optionally, skip connections. Because of this, the system can effectively use more powerful optimizers like K-FAC (Martens et al. 2020, arXiv:1503.05671) or Shampoo (Gupta et al. 2018, arXiv:1802.09568) to determine the updates. For example, the system can use larger batch sizes due to not increasing normalization layers, improving the effectiveness of the powerful optimizers. This results in neural networks that train faster, attain better performance once trained, or both.

FIG. 3 is a flow diagram of an example process 300 for training a neural network that has transformed activation function layers. For convenience, the process 300 will be described as being performed by a system of one or more computers located in one or more locations. For example, a neural network system, e.g., the neural network system 100 of FIG. 1, appropriately programmed, can perform the process 300.

The system obtains data specifying the architecture of the neural network (step 302). That is, the system obtains data specifying the connectivity of the layers of the neural network and the properties of the layers. For example, the system can obtain data representing the directed graph that represents the architecture of the neural network.

As described above, the neural network can have any appropriate architecture that includes multiple transformed activation function layers.

The system initializes the parameter values of the layers of the neural network (step 304).

In particular, the system initializes the parameter values of the layers of the neural network for computing the local and global C and Q maps as described above. The parameter values (weights) of the neural network can be initialized according to a random initialization scheme.

As one example, for a fully-connected layer, the system can initialize the weight matrix as a uniform orthogonal matrix, in particular a scale-corrected uniform orthogonal matrix. In other words, the system can initialize each element of the weight matrix for layer l of the neural network by sampling a value from a distribution with a variance that depends inversely on a dimensionality of the layer input, e.g., from the distribution [symbol] (0,1/dₗ).

For a convolutional layer, i.e., a layer that computes a convolution between a filter bank tensor for the layer and the layer input, the system can, e.g., initialize the filter bank tensor for the layer using Delta initialization. In Delta initialization, all weights except those in a central location/offset of the filter bank tensor (filter) are initialized to zero. As an example, if the layer has a 5×5 filter, then only the weights corresponding to entry (3; 3) in the filter bank tensor would be non-zero. The Delta initialization can uses an entry-wise Gaussian distribution, i.e., entries in the filter bank tensor can be drawn from a Gaussian distribution.

Thus, the non-zero weights of a Delta-initialized filter bank form an m×k matrix, where k is the input channel dimension and m is the output channel dimension.

In some implementations, to initialize this matrix, the system uses an entry-wise Gaussian distribution, e.g., samples each entry of the matrix from a Gaussian distribution that has mean 0 and variance 1/k.

In some implementations, the system uses a scaled-corrected uniform orthogonal (SUO) distribution, which is a distribution of rescaled orthogonal matrices, e.g., rescaled according to input channel and output channel dimensions of the filter bank. When m≤k the system can generate a sample from this distribution as (XX^{T})^{-1/2}^{^{T}}, where X is a m×k matrix with entries sampled iid from a Gaussian distribution that has mean 0 and variance 1. When m>k, the system can generate a sample from this distribution as (XX^{T})^{-1/2}^{^{T}}, where X is a k×m matrix with entries sampled iid from a Gaussian distribution that has mean 0 and variance 1. The system can then multiply by the scaling factor max (

$$\sqrt{\frac{m}{k}} ,$$

1).

When the layer has a bias, the system can initialize all elements of the bias to zero.

The system determines constant values for the transformed activation function layers (step 306).

In particular, as described above, the system can determine the constant values such that one or more constraints that are based on the local C maps and Q maps of the plurality of neural network layers are satisfied. In particular, the constraints can be constraints on the global C and Q maps of the neural network.

The constraints that are used by the system can depend on the type of activation function and, accordingly, the input and output transformation constants that are used.

As a particular example and as described above, in some implementations, given an activation function φ, the transformed activation output \hat{φ} (x) for an activation input x can be equal to:

\hat{φ} (x)=γ(φ(αx+β)+δ),

where α and β are the input transformation constants, and δ and γ are the output transformation constants.

In some of these examples, the system can set the values of the input and output transformation constants such that:

μ_{f}¹( [symbol] (1)=ç,

[symbol]

_{f}(0)=0,

Q(1)=1, and

Q′(1)=1,

where μ_{f}¹( [symbol] ′(1) is an optional constraint on an estimate of a maximal slope function that satisfies:

$${μ}_{f}^{1} ( {𝒞}^{′} ( 1 ) = {max}_{g : g ⊆ f} {𝒞}_{g}^{′} ( 1 ) , g ⊆ f$$

denotes that g is a subnetwork of the neural network f and ç is a hyperparameter that is greater than 1, e.g., that generally represents (specifies or defines) a degree of nonlinearity of the operations performed by the neural network at initialization. However there is no need to determine the degree of nonlinearity in order to determine ç. For example ç can be chosen to be a value between 1 and 2, e.g., 1.5. The constraint on the subnetworks can represent a constraint that all the layers of the neural network, in all of its subnetworks, are readily trainable.

A subnetwork of a neural network is defined as a (non-strict) connected subset of the layers in the neural network that constitute a neural network with a singular input and output layer. So for example, layers 3, 4 and 5 of a 10 layer MLP form a subnetwork, while layers 3, 4, and 6 do not.

Thus, in this example, the one or more input transformation constants and the one or more output transformation constants include a constraint that is based on the hyperparameter and on an estimate of a maximal slope function of the neural network at initialization.

In others of these examples, when the activation function is a smooth function (i.e., a function that has at least a continuous first derivative), the system can compute the input and output transformation constants so that the following constraints are satisfied:

μ_{f}²( [symbol] ″(1))=τ,

[symbol]

′(1)=1,

Q(1)=1, and

Q′(1)=1,

where μ_{f}²( [symbol] ″(1)) is an estimate of the maximal curvature function that satisfies:

$${μ}_{f}^{2} ( {𝒞}^{″} ( 1 ) ) = {max}_{g : g ⊆ f} {𝒞}_{g}^{″} ( 1 ) ,$$

and where τ is a constant hyperparameter value that is between zero and one, e.g., set to a value between 0.1 and 0.5.

Another example described above is that, when the activation function is a leaky rectified linear unit (ReLU) activation function φ_{α}, the transformed activation output [symbol] (x) for an activation input x can be equal to:

$$( x ) = \sqrt{\frac{2}{1 + {α}^{2}}} ( {φ}_{α} ( x ) ) ,$$

where φ_{α}(x) is the leaky ReLU function. In this example, the system can determine a value of α such that the following constraints are satisfied:

[symbol]

_{f}′(1)=1,

μ_{f}⁰(α)=η, and

Q(q)=q,

where μ_{f}⁰α is an estimate of the maximal c value function that satisfies:

$${μ}_{f}^{0} ( a ) = {max}_{g : g ⊆ f} ( {𝒞}_{g} ( 0 ) )$$

and η is a hyperparameter that is between zero and one inclusive.
For example, the system can set 77 equal to a value between 0.8 and one, e.g., 0.85, 0.9, or 0.95.

In any of the above examples, the system can determine the values of the constants that satisfy the constraints using any appropriate numerical analysis technique, e.g., binary search, numerical solvers, and so on.

The system trains the neural network (step 308) on training data. As described above, during the training, the system adjusts the parameter values of the layers of the neural network while keeping the constant values fixed.

Additionally, as described above, the system is able to use a more powerful optimizer for the training than for neural networks that include, e.g., normalization layers, allowing the neural network training to converge faster, to result in a better performing neural network, or both.

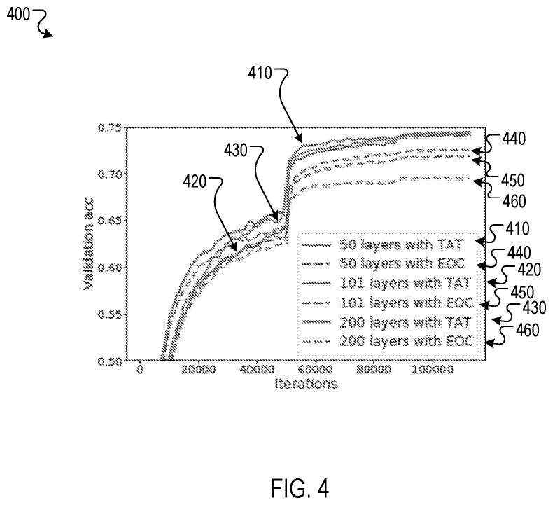

FIG. 4 is a chart 400 that shows the performance of the described techniques relative to a conventional technique.

In particular, the chart 400 shows the performance of six models:
(i) A model 410, which is a convolutional neural network with 50 layers, trained with “TAT,” which refers to the above described techniques, with leaky ReLU activations
(ii) A model 420, which is a convolutional neural network with 101 layers, trained with “TAT,” which refers to the above described techniques, with leaky ReLU activations
(iii) A model 430, which is a convolutional neural network with 200 layers, trained with “TAT,” which refers to the above described techniques, with leaky ReLU activations
(iv) A model 440, which is a convolutional neural network with 50 layers and using ReLU activations and trained with Edge of Chaos (“EOC,”) a conventional training scheme
(v) A model 450, which is a convolutional neural network with 101 layers, and using ReLU activations and trained with “EOC,” a conventional training scheme
(vi) A model 460, which is a convolutional neural network with 200 layers, and using ReLU activations and trained with “EOC,” a conventional training scheme

In particular, the chart 400 shows, for each model, the Top-1 validation accuracy (“validation acc”) of the model after different number of training iterations (“iterations”) on an image classification data set (ImageNet). Each model is trained using the same optimizer (K-FAC) and none of the models include skip/residual connections or normalization layers.

As can be seen from the chart 400, the described techniques result in better accuracy than the EOC models and the validation accuracies do not decrease with the number of layers. This is, at least in part, because the described techniques initialize the neural network in a way that allows the neural network to have increased training stability and allows the optimization power of the K-FAC optimizer to be directly leveraged.

Table 1 shows additional results comparing the top-validation accuracy of the described techniques (“TAT”) with two different activation functions (leaky ReLU and Tanh) and two different optimizers (K-FAC and stochastic gradient descent (SGD) for different depths (#s of neural network layers). As can be seen from Table 1, the described techniques outperform EOC for a variety of different optimizers, activation functions, and layer depths.

TABLE 1

| Depth | Optimizer | Method | (L)ReLU | Tanh |
|---|---|---|---|---|
| 50 | K-FAC | EOC | 72.6 | 70.6 |
| | | TAT | 74.6 | 73.1 |
| | SGD | EOC | 63.7 | 55.7 |
| | | TAT | 71.0 | 69.5 |
| 101 | K-FAC | EOC | 71.8 | 69.2 |
| | | TAT | 74.2 | 72.8 |
| | SGD | EOC | 41.6 | 54.0 |
| | | TAT | 70.0 | 69.0 |

Table 2 shows additional results comparing the top-validation accuracy of the described techniques with leaky ReLU activations (“TReLU”) with an EOC technique using two variants of the parameteric ReLU (PRELU) activation function and two different optimizers (K-FAC and stochastic gradient descent (SGD) for different depths (#s of neural network layers). As can be seen from Table 2, the described techniques outperform parameteric ReLU for a variety of different optimizers, activation functions, and layer depths.

TABLE 2

| Depth | Optimizer | TReLU | PReLU_{0.0} | PReLU_{0.25} |
|---|---|---|---|---|
| 50 | K-FAC | 74.6 | 72.5 | 73.6 |
| | SGD | 71.0 | 66.7 | 67.9 |
| 101 | K-FAC | 74.2 | 71.9 | 72.8 |
| | SGD | 70.0 | 54.3 | 66.3 |

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving a network input; and
processing the network input using a neural network that comprises a plurality of neural network layers arranged as a directed graph to generate a network output for the network input, the plurality of neural network layers comprising a plurality of transformed activation function layers, and wherein processing the network input comprises, for each transformed activation function layer:
receiving a layer input for the transformed activation function layer;
generating, from the layer input, an activation input to an element-wise activation function for the transformed activation layer;
transforming the activation input using one or more input transformation constants to generate a transformed activation input;
applying the element-wise activation function to the transformed activation input to generate an initial activation output;
transforming the initial activation output using one or more output transformation constants to generate a transformed activation output, wherein the one or more input transformation constants and the one or more output transformation constants are based on properties of the neural network when the neural network is initialized prior to training the neural network; and
providing the transformed activation output as a layer output for the transformed activation function layer.

2. The method of claim 1, wherein generating, from the layer input, an activation input to an element-wise activation function for the transformed activation layer comprises:
applying an affine operation to the layer input.

3. The method of claim 1, wherein generating, from the layer input, an activation input to an element-wise activation function for the transformed activation layer comprises:
using the layer input as the activation input.

4. The method of claim 1, wherein transforming the activation input using one or more input transformation constants to generate a transformed activation input comprises:
generating an initial transformed activation input by multiplying the activation input by an input scale constant.

5. The method of claim 4, wherein transforming the activation input using one or more input transformation constants to generate a transformed activation input comprises:
generating the transformed activation input by adding an input shift constant to the initial transformed activation input.

6. The method of claim 1, wherein the activation function is a leaky RELU activation function that, for a given element, (i) is an identity operation when the given element is greater than or equal to zero and (ii) multiplies the given element by a slope value when the given element is less than zero, and wherein an output scale constant is defined by the slope value.

7. The method of claim 6, wherein the output scale constant is equal to a square root of a ratio between (i) 2 and (ii) a sum of one and a square of the slope value.

8. The method of claim 1, wherein transforming the initial activation output using one or more output transformation constants to generate a transformed activation output comprises:
generating a shifted initial activation output by adding an output shift constant to the activation output.

9. The method of claim 8, wherein transforming the initial activation output using one or more output transformation constants to generate a transformed activation output comprises:
generating the transformed activation output by multiplying the shifted initial activation output by an output scale constant.

10. The method of claim 9, wherein the activation function is a smooth activation function and wherein the output scale constant is based on a value of the shifted initial activation output for an element that has a value sampled from a noise distribution.

11. The method of claim 1, wherein the plurality of neural network layers comprise one or more normalized summation layers, and wherein processing the network input comprises, for each normalized summation layer:
receiving for each of a plurality of neural network layers that are connected to the normalized summation layer by an incoming edge in the directed graph, a respective layer output generated by the neural network layer during the processing of the network input;
applying a respective normalized weight to each of the respective layer outputs to generate a respective weighted layer output, wherein a sum of the squares of the respective normalized weights is equal to one; and
generating a layer output for the normalized summation layer by summing the respective weighted layer outputs.

12. The method of claim 1, wherein, for one or more of the plurality of transformed activation function layers, generating, from the layer input, an activation input to an element-wise activation function for the transformed activation layer comprises:
computing a convolution between a filter bank tensor for the layer and the layer input.

13. The method of claim 12, further comprising:
for each of the one or more transformed activation function layers, prior to training the neural network, initializing the filter bank tensor for the layer using Delta initialization.

14. The method of claim 13, wherein the Delta initialization uses an entry-wise Gaussian distribution.

15. The method of claim 13, wherein the Delta initialization uses a scaled-corrected uniform orthogonal (SUO) distribution.

16. The method of claim 1, wherein the one or more input transformation constants and the one or more output transformation constants are also based on a hyperparameter that represents a degree of nonlinearity of the operations performed by the neural network at initialization.

17. The method of claim 16, wherein the one or more input transformation constants and the one or more output transformation constants are based on the hyperparameter and an estimate of a maximal slope function of the neural network at initialization.

18. The method of claim 1, wherein the one or more input transformation constants and the one or more output transformation constants for each of the layers are selected such one or more constraints that are based on values of local C maps, local Q maps, or both for the plurality of layers in the neural network are satisfied.

19. The method of claim 18, wherein the one or more constraints are based on values of local C maps, wherein a local C map is a function that characterizes how well a cosine similarity function is preserved between the input and the output of a neural network layer, wherein a global C map comprises a composition local C maps for the plurality of neural network layers, and wherein the one or more input transformation constants and the one or more output transformation constants are selected based on a constraint on the global C map that represents preservation of the cosine similarity function by the neural network.

20. The method of claim 18, wherein the one or more constraints are based on values of local Q maps, wherein a local Q map is a function that characterizes a change in a squared magnitude of the element-wise activation function between the input and the output of a neural network layer, and wherein the one or more input transformation constants and the one or more output transformation constants are selected based on a constraint on the local Q map.

21. The method of claim 18, wherein at least one of the constraints is based on the hyperparameter and the estimate of the maximal slope function.

22. The method of claim 1, where processing the network input using the neural network comprises:
applying normalization to the network input to generate a normalized input; and
providing the normalized input as a layer input for one or more initial neural networks of the neural network.

23. The method of claim 1, wherein the network input is received during training of the neural network and wherein the method further comprises:
obtaining a target network output for the network input;
determining a gradient with respect to a set of parameters of the neural network of a loss function for the training of the neural network that measures a quality of the network output relative to the target network output; and
determining an update to the parameters of the neural network based at least on the gradient.

24. A system comprising:
one or more computers; and
one or more storage devices storing instructions that, when executed by the one or more computers, cause the one or more computers to perform operations comprising:
receiving a network input; and
processing the network input using a neural network that comprises a plurality of neural network layers arranged as a directed graph to generate a network output for the network input, the plurality of neural network layers comprising a plurality of transformed activation function layers, and wherein processing the network input comprises, for each transformed activation function layer:
receiving a layer input for the transformed activation function layer;
generating, from the layer input, an activation input to an element-wise activation function for the transformed activation layer;
transforming the activation input using one or more input transformation constants to generate a transformed activation input;
applying the element-wise activation function to the transformed activation input to generate an initial activation output;
transforming the initial activation output using one or more output transformation constants to generate a transformed activation output, wherein the one or more input transformation constants and the one or more output transformation constants are based on properties of the neural network when the neural network is initialized prior to training the neural network; and
providing the transformed activation output as a layer output for the transformed activation function layer.

25. One or more non-transitory computer-readable storage media storing instructions that when executed by one or more computers cause the one or more computers to perform operations comprising:
receiving a network input; and
processing the network input using a neural network that comprises a plurality of neural network layers arranged as a directed graph to generate a network output for the network input, the plurality of neural network layers comprising a plurality of transformed activation function layers, and wherein processing the network input comprises, for each transformed activation function layer:
receiving a layer input for the transformed activation function layer;
generating, from the layer input, an activation input to an element-wise activation function for the transformed activation layer;
transforming the activation input using one or more input transformation constants to generate a transformed activation input;
applying the element-wise activation function to the transformed activation input to generate an initial activation output;
transforming the initial activation output using one or more output transformation constants to generate a transformed activation output, wherein the one or more input transformation constants and the one or more output transformation constants are based on properties of the neural network when the neural network is initialized prior to training the neural network; and
providing the transformed activation output as a layer output for the transformed activation function layer.
